(19) United States
(12) Patent Application Publication
(10) Pub. No.: US 2014/0299279 A1
(43) Pub. Date: Oct. 9, 2014

(54) MOVABLE MOSQUITO SCREEN, PARTICULARLY FOR WINDOWS, DOORS AND THE LIKE

(71) Applicant: MV LINE S.P.A, ACQUVIVA DELLE FONTI (IT)

(72) Inventor: Paolo Montanaro, Casamassima (IT)

(73) Assignee: MV LINE S.P.A, ACQUAVIVA DELLE FONTI (IT)

(21) Appl. No.: 14/355,345

(22) PCT Filed: Sep. 21, 2012
(86) PCT No.: PCT/EP2012/068637

§ 371 Date: Apr. 30, 2014

(30) Foreign Application Priority Data
Nov. 2, 2011 (IT) BO2011A000614

(51) Int. Cl. E06B 9/54

(52) U.S. Cl. CPC E06B 9/54
USPC 160/89

(57) ABSTRACT

A movable mosquito screen, particularly for windows, doors and the like, which comprises a fine mesh net which is provided with a substantially perimetric frame, which can be installed in an opening in an element of the type of a wall and the like, comprises a fixed box, which is coupled to an edge of the net and is associated stably with a corresponding margin of the opening, and a movable box, which is fixed on the side opposite to the net and can perform a translational motion on command, along a direction which is substantially perpendicular to the fixed box, for transition from a first configuration, in which the net is substantially gathered around the fixed box, to a second configuration, in which the net is extended so as to block the opening, and vice versa, the frame comprises at least one flexible tape.

The present invention relates to a movable mosquito screen, particularly for windows, doors and the like.

As is known, one of the contrivances most often adopted for protecting dwellings and other buildings from bothersome insects such as mosquitoes, flies, shield (or “stink”) bugs etc., consists in arranging sheets constituted by fine mesh metallic nets to cover windows and doors, in order to prevent the entry of such insects into the dwelling, even if the respective window or door is open.

More precisely, according to a widespread implementation solution, such metallic nets, which are typically square or rectangular (complementary to the shape of the opening closed by the window or by the door), have a perimetric frame comprising a first rigid upright at a side thereof, which is intended to be fixed to a jamb of the window frame, and a second rigid upright, at the opposite side.

The second upright is movable so as to allow the unwinding of the net from a first configuration, in which the latter is completely wound about the first upright, to a second configuration, in which the net is completely unwound, covering the opening, in order to allow the mosquito screen to perform its function as a screen against insects.

The mosquito screen is moreover associated with two flexible link tracks, which form, at the top and at the bottom, a guide for the movement of the second upright, preventing its flexion and/or deviation from the optimal path.

Each one of such link tracks is thus constituted by a plurality of segments which are aligned and mutually articulated, and which form, with the side facing toward the net, a seat which is typically U-shaped for slideably accommodating the respective end portion of the second upright.

In this manner, when the second upright performs a translational motion to bring the mosquito screen from the first configuration to the second configuration, the respective end portions slide in the corresponding seats of the link tracks, which at the same time are strung out along the base and the top of the opening delimited by the window (where they are accommodated in fixed profiles which hide them from view).

However, when the second upright performs a translational motion in the opposite direction, winding the net around the first upright, each link track is progressively inserted (thanks to the ability to bend, ensured by the presence of the mutually articulated segments) in a bezel which is fixed to the second upright, reascending it.

In this manner, the link tracks, which are aesthetically unpleasant to the end user, perform the function of a guide for the net, while at the same time keeping constantly hidden from view, without therefore compromising the overall appearance of the product.

Such implementation solution is not however devoid of drawbacks.

In fact, the use of guiding elements that are constituted by a plurality of mutually articulated segments, thus forming link tracks as described, is a source of considerable costs (linked to the specific type of such mechanical elements, which are relatively expensive and complex to install and maintain), which are difficult to contain within the retail price of the mosquito screen.

Moreover, it must be pointed out that the choice to adopt link tracks of the type described above imposes considerable encumbrances which force the manufacturers to find complex solutions in order to obtain a correct sizing of the various interconnected elements that go to make up the mosquito screen.

The aim of the present invention is to solve the above-mentioned problems, by providing a movable mosquito screen which is aesthetically pleasing and is provided with means for guiding the sheet which is arranged to screen the window, door, or the like, on which it is installed.

Within this aim, an object of the invention is to provide a movable mosquito screen which is low-cost.

Another object of the invention is to provide a movable mosquito screen, the elements of which for guiding the screening net have contained encumbrances.

A further object of the invention is to provide a movable mosquito screen that ensures a high reliability of operation.

Another object of the invention is to provide a movable mosquito screen that can be easily implemented using elements and materials that are readily available on the market.

Another object of the invention is to provide a movable mosquito screen which is safe to use.

This aim and these objects and others which will become more apparent hereinafter are achieved by a movable mosquito screen, particularly for windows, doors and the like, comprising a fine mesh net which is provided with a substantially perimetric frame that can be installed at an opening in an element of the type of a wall and the like, said frame comprising a fixed box, which is coupled to an edge of said net and is associated stably with a corresponding margin of the opening, and a movable box, which is fixed on the side opposite to said net and can perform a translational motion on command, along a direction that is substantially perpendicular to said fixed box, for transition from a first configuration, in which said net is substantially gathered around said fixed box, to a second configuration, in which said net is extended so as to block said opening, and vice versa, characterized in that said substantially perimetric frame comprises at least one flexible tape, which is fixed with a first end thereof to said fixed box and has a transverse cross-section that is at least partially U-shaped, so as to form a guiding seat for at least one corresponding end portion of said movable box and for said net.

Further characteristics and advantages of the invention will become more apparent from the description of a preferred, but not exclusive, embodiment of the movable mosquito screen according to the invention, which is illustrated by way of non-limiting example in the accompanying drawings wherein:

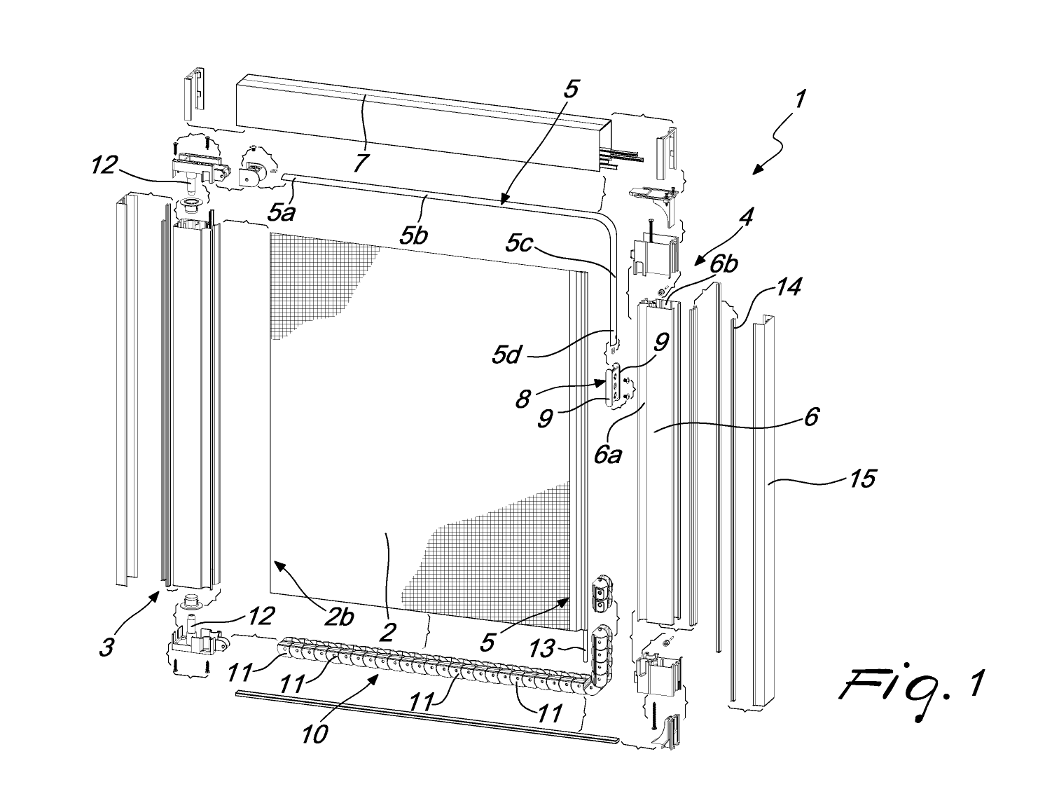

FIG. 1 is an exploded perspective view of the mosquito screen according to the invention;

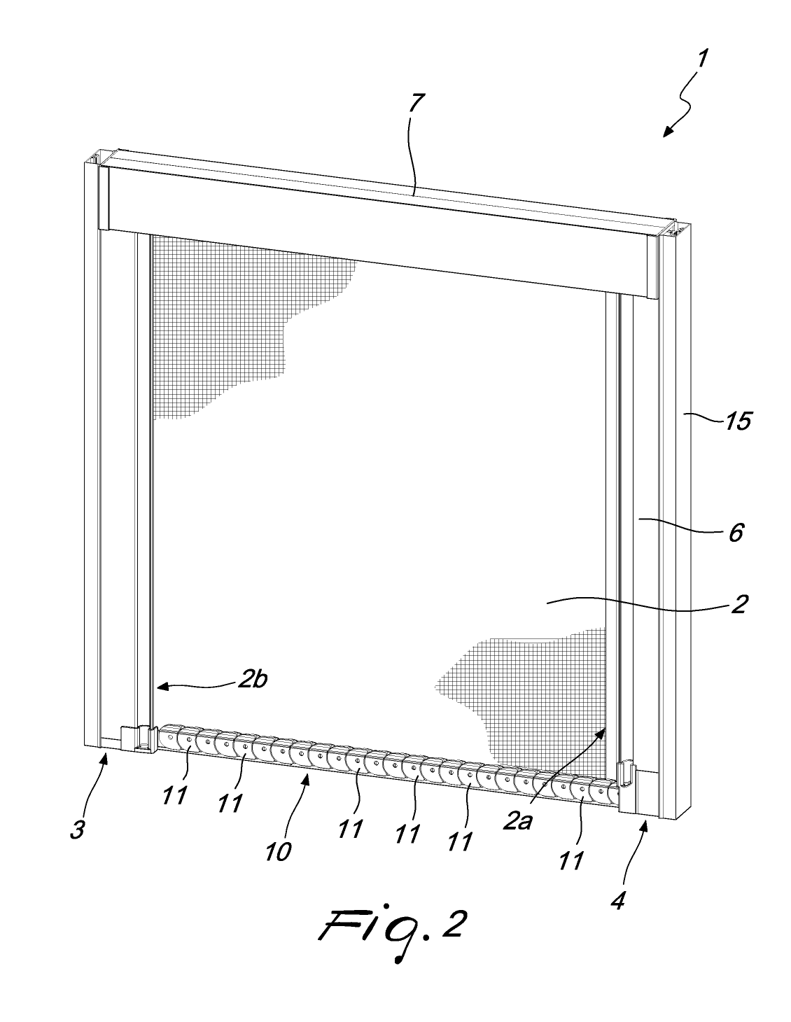

FIG. 2 is a perspective view of the mosquito screen according to the invention with the net completely extended;

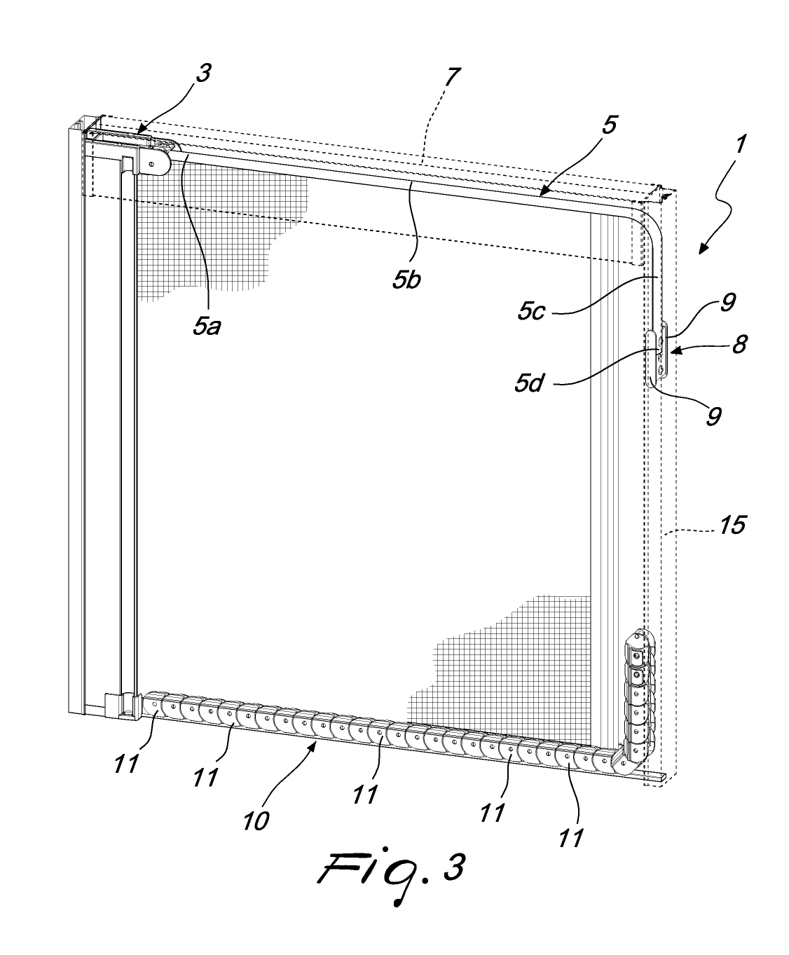

FIG. 3 is a perspective view of the mosquito screen according to the invention with the net completely extended and with some elements shown transparent;

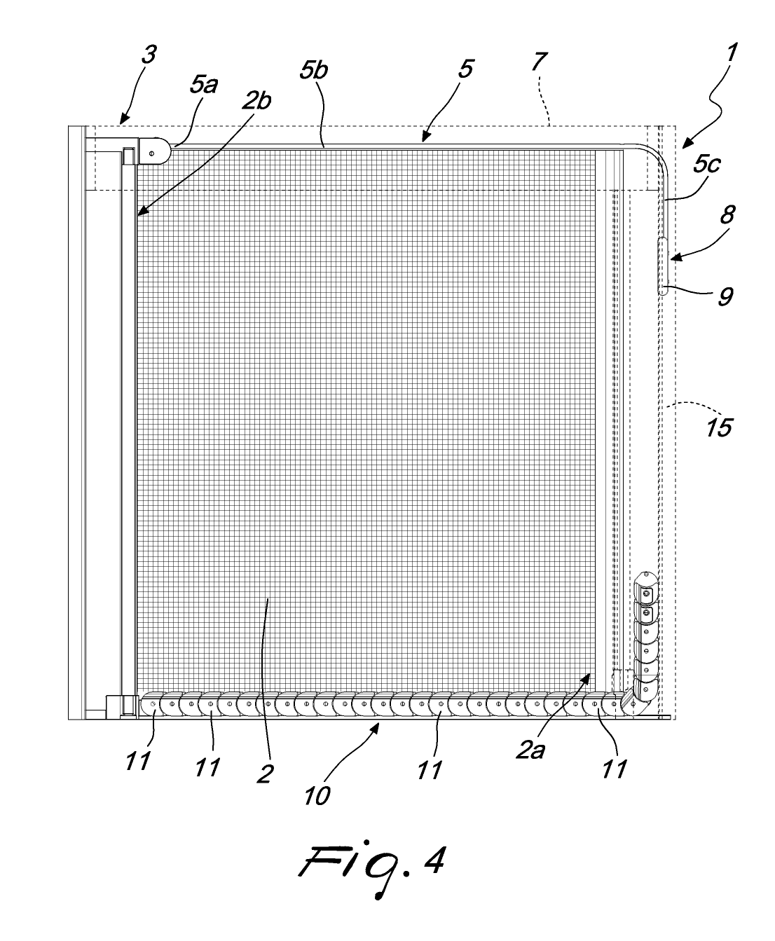

FIG. 4 is a front elevation view of the mosquito screen according to the invention with the net completely extended and with some elements shown transparent;

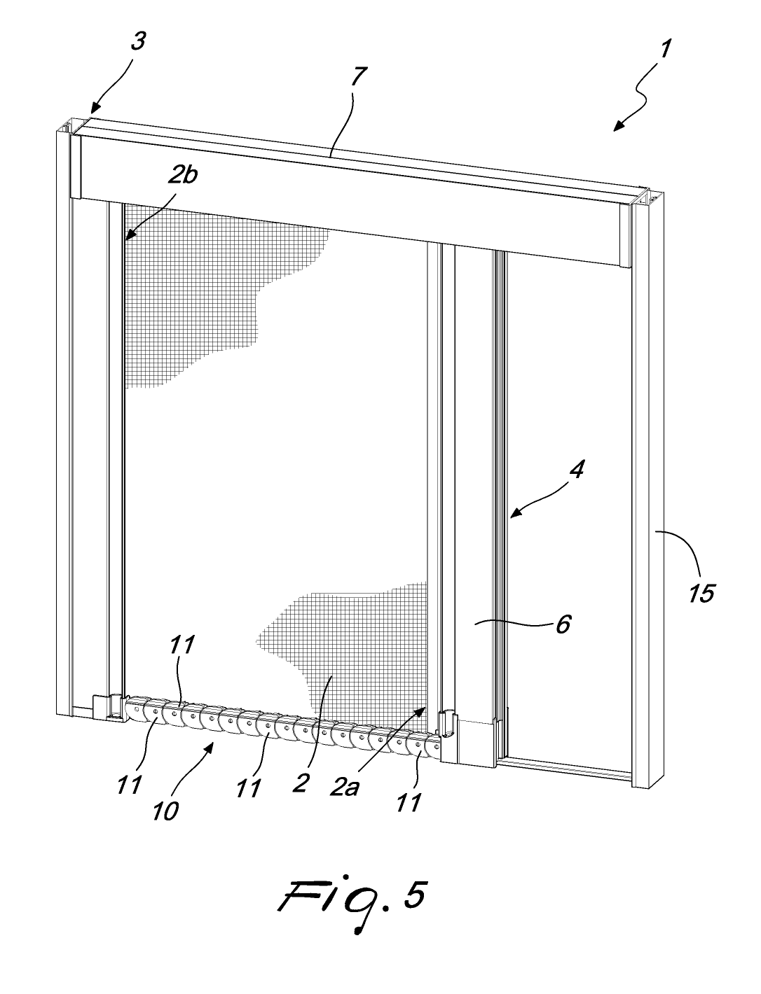

FIG. 5 is a perspective view of the mosquito screen according to the invention with the net partially retracted;

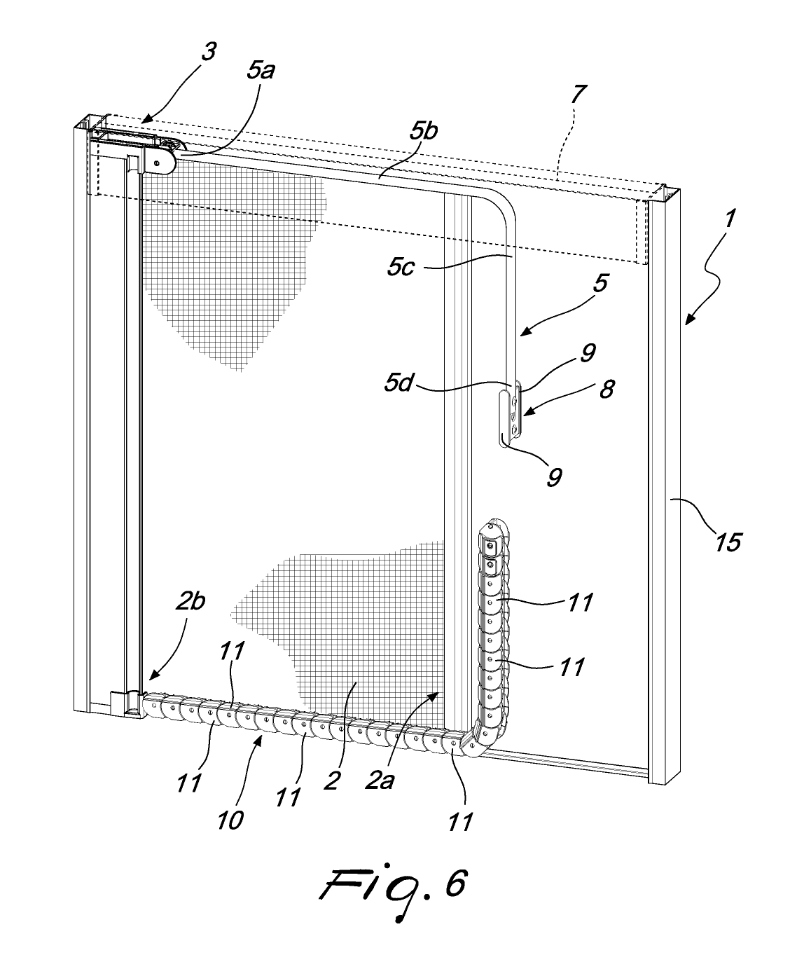

FIG. 6 is a perspective view of the mosquito screen according to the invention with the net partially retracted and with some elements shown transparent;

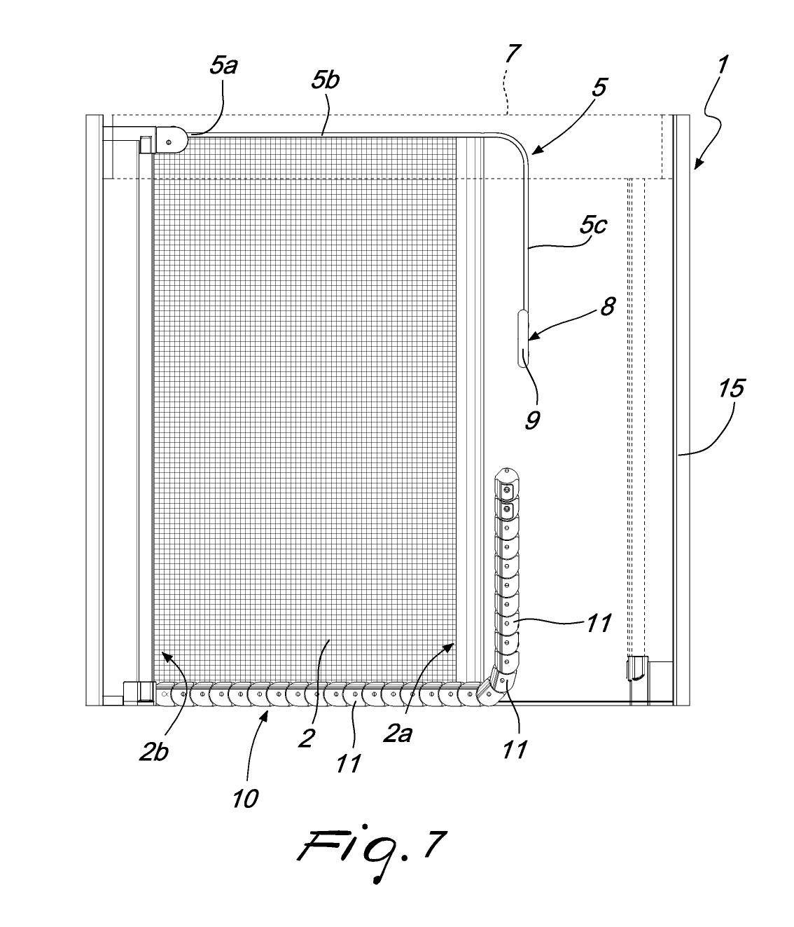

FIG. 7 is a front elevation view of the mosquito screen according to the invention with the net partially retracted and with some elements shown transparent;

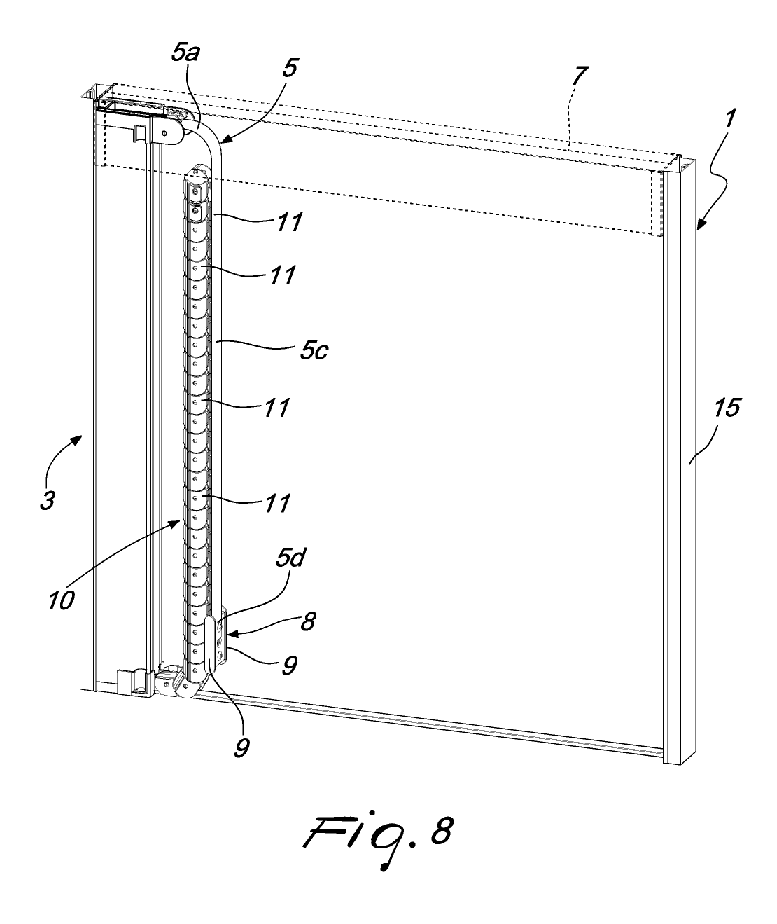

FIG. 8 is a perspective view of the mosquito screen according to the invention with the net completely retracted and with some elements shown transparent;

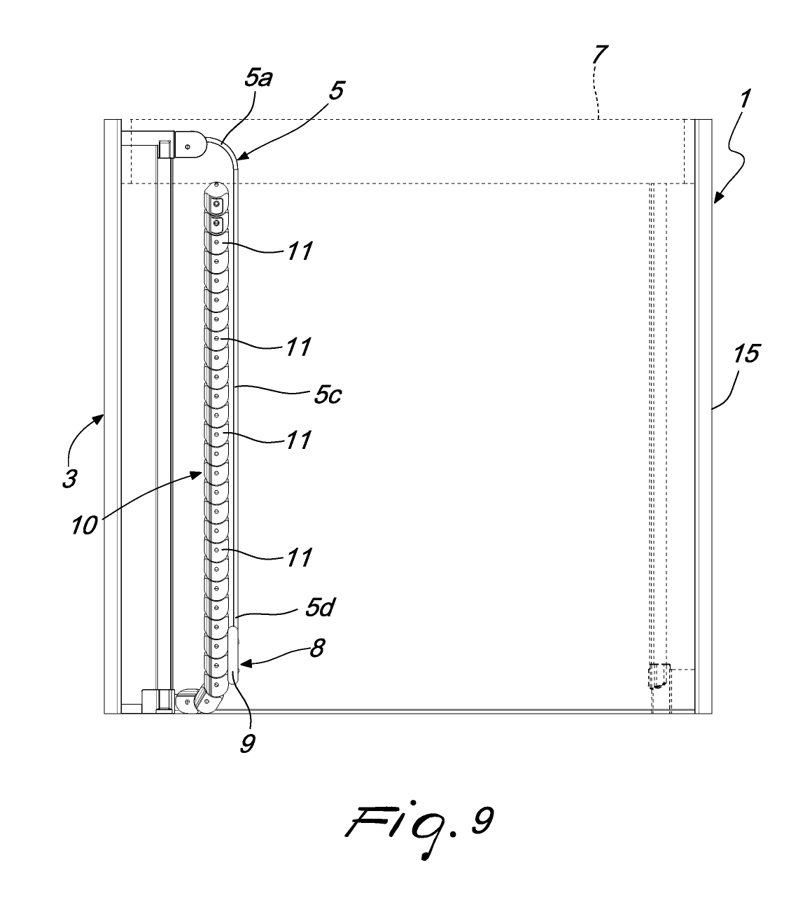

FIG. 9 is a front elevation view of the mosquito screen according to the invention with the net completely retracted and with some elements shown transparent.

With reference to the figures, the movable mosquito screen according to the invention, generally designated by the reference numeral 1, is particularly adapted to windows, doors and the like, for the purpose of constituting a screen against the entry of insects and other bothersome pests into dwellings and into other buildings, when the window (or the door) is open.

The mosquito screen 1 comprises a fine mesh net 2 made of a material preferably (but not exclusively) selected from a metallic material and a polymeric material and is provided with a substantially perimetric frame which can be installed at an opening (intended to be closed by the window or by the door) in an element of the type of a wall and the like.

Thus according to known methods, the net 2 can be deployed to completely screen the opening in the wall, thus preventing insects from entering the building or the room delimited by the wall, when the window (or the door) is open, and being superimposed on the latter when it is closed.

The frame comprises a fixed box 3, which is coupled to an edge of the net 2 and is associated stably with a corresponding margin of the opening (and possibly of the fixed frame of the window or of the door); moreover, the frame comprises a movable box 4, which is fixed on the side opposite to the net 2 (with respect to the fixed box 3) and can perform a translational motion on command, along a direction that is substantially perpendicular to the fixed box 3.

In this manner, a user, who for example grips a handle arranged along the movable box 4 (or grips the movable box 4 itself at adapted holes which are contoured to receive the fingers), can determine the transition of the mosquito screen 1 from a first configuration (shown in FIGS. 8 and 9), in which the net 2 is substantially gathered around the fixed box 3 (and thus does not screen the opening) to a second configuration (in turn shown in FIGS. 2 to 4), in which the net 2 is extended to block the opening, and vice versa.

Moreover, it should be noted that in the accompanying figures (and more precisely in FIGS. 5 to 7) the mosquito screen 1 according to the invention is shown with the net 2 only partially unwound (in an arrangement which thus is intermediate between the first configuration and the second configuration introduced above).

According to the invention, the substantially perimetric frame comprises at least one flexible tape 5, which is fixed with a first end 5a thereof to the fixed box 3 and has a transverse cross-section that is at least partially U-shaped (with the cavity directed toward the tape 5), so as to form a guiding seat for at least one corresponding end portion of the movable box (and for the net 2), which can thus slide within such guiding seat during the transition from the first configuration to the second configuration, and vice versa.

It should be noted that the tape can preferably be made of a material selected from a metallic material, a polymeric material and a composite material (but the use is not ruled out of different types of material, according to specific requirements).

Conveniently, the movable box 4, which is often also referred to as the “bar handle”, comprises a profile 6, which on the inside defines a channel 6a which is designed to receive a first end flap 2a of the net 2, opposite to the fixed box 3.

In the first configuration (shown, as previously mentioned, in FIGS. 8 and 9 and in which the movable box 4 is substantially contiguous to the fixed box 3), the tape 5 is, as has been said, fixed with a first end 5a thereof to the fixed box 3 but is substantially entirely contained in a duct 6b within the profile 6 (which hides it from view).

During the transition from the first configuration to the second configuration, the tape 5 exits progressively from the duct 6b with a first portion 5b (the length of which increases as the movable box 4 moves away from the fixed box 3), while a second part 5c of the tape 5, which is complementary to the first portion 5b, remains inserted in the duct 6b of the profile 6.

So in fact, at every moment of its travel from the first configuration to the second configuration, and vice versa, the end portion of the movable box 4 ideally divides the tape 5 into a first portion 5b and a second portion 5c (mutually inclined at 90°, thanks to the flexibility of the tape 5 itself), with the second portion 5c being kept inserted in the duct 6b of the profile 6.

More specifically, the first portion 5b, which is provided with the aforementioned first end 5a which is fixed to the fixed box 3, is extended transversely with respect to the latter and with respect to the movable box 4 (according to the advancement direction of the latter) and faces the side of the net 2, so as to guide the movable box 4 and the net 2 during the transition from the first configuration to the second configuration, and vice versa. Moreover, such first portion 5b can be completely accommodated (and hidden from the view of a user) in a curved bezel 7 (which, in addition to accommodating the tape 5, with its inner walls contributes to guiding the movement of the movable box 4).

According to an embodiment of important practical interest, cited by way of non-limiting illustration of the application of the invention, the net 2 has a substantially rectangular (or square) shape. Moreover, both the fixed box 3 and the movable box 4 are arranged at the vertical sides of the net 2, when the frame is installed in the opening.

According to such application therefore, the movement of the movable box 4 (and the movement of extension and reclosing of the net 2) occurs along a direction that is substantially horizontal, and the first portion 5b of the tape 5 substantially faces either the upper horizontal side or the lower horizontal side of the net 2 (with the frame installed in the opening). For example, in the accompanying figures, an embodiment is proposed which involves the use of a tape 5 the first portion 5b of which surmounts the net 2 and thus faces its upper horizontal side.

It should be noted however that the possibility is not ruled out of installing frames 3 in which the boxes 3, 4 are oriented substantially horizontally (or even inclined, as a function of the specific application), and the movement of the movable box 4 is thus directed from above and downward, or vice versa (or even inclined).

Conveniently, the movable mosquito screen 1 comprises a terminal 8, which is fixed to a second end 5d of the tape 5, on the side opposite to the first end 5a, so as to constitute, possibly according to known methods, a reference for an apparatus for tensioning the tape 5 itself Such terminal 8 comprises a plate, which can be fixed (for example with one or more screws) to the aforementioned second end 5d of the tape 5 and is arranged substantially on the plane of the second portion 5c.

Moreover, the terminal 8 has two flat wings 9, which are anchored at right angles to the sides of the plate: the center distance of such wings 9 is substantially equal to the width of the duct 6b and this allows the wings 9 to slide along the inner surface of the duct 6b, effectively guiding the movement (in entry or egress) of the second portion 5c inside the duct 6b of the profile 6.

According to an alternative embodiment, shown for the purposes of non-limiting example in the accompanying figures, the frame comprises the tape 5 and a link track 10, which are fixed to opposite ends of the fixed box 3 and both face the net 2 (for example, in the accompanying figures a solution is proposed in which the link track 10 is arranged at least partially below the net 2, while the tape 5, with its first portion 5b, as previously observed faces the top of the net 2).

The link track 10 is constituted by a plurality of segments 11 which are articulated in pairs and form, with respective contoured walls of each segment 11, a guiding groove (similar to the guiding seat formed by the tape 5) for the respective end portion of the movable box 4.

The contoured walls of the segments 11 in turn have a center distance that is substantially equal to the width of the duct 6b, so that the link track 10 can also slide guided inside the profile 6 substantially parallel to the tape 5 (as can clearly be seen from the accompanying figures).

Similarly to the observations for the plate, it should be noted that the end segment 11 of the link track 10, on the end opposite to the fixed box 3, or another conveniently-provided end component, is also capable of constituting, again possibly according to known methods, a reference for the tensioning apparatus, so as to keep the link track 10 correctly tensioned in addition to the tape 5.

Moreover, it should be noted that the scope of protection claimed herein includes mosquito nets 1 which are provided with a tape 5 and are provided, on the opposite side, with a simple guide and/or abutment element, conventional or otherwise.

According to the preferred, but not exclusive, embodiment, the fixed box 3 comprises a roller that can rotate about its own substantially vertical axis and is rigidly fixed to a second end flap 2b of the net 2 (opposite to the first end flap 2a), and more precisely the roller can be rotatably and coaxially installed on pins 12 which are rigidly coupled to the opening (and possibly to the frame of the door or of the window that delimits it).

In the first configuration the net 2 is wound around the roller. During the transition from the first configuration to the second configuration, the net 2 is unwound from the roller (while the latter rotates about its axis) and is thus progressively brought to block the opening.

It should be observed that the scope of protection claimed herein includes the provision of mosquito nets 1 in which the net 2 is not wound around a rotatable roller, but for example is folded on itself, thanks to a pleating obtained in a preliminary processing step.

Conveniently, as can be seen in FIG. 1, for keeping the net 2 constantly extended and in tension and for preventing it from folding in on itself, the mosquito screen 1 comprises a stiffening stem 13, which is inserted in an inner sheath of the first end flap 2a of the net 2; such stem 13 therefore, as with the first end flap 2a, can be accommodated inside the profile 6 (in the channel 6a).

The operation of the movable mosquito screen is thus evident from the foregoing explanation. As we have seen in fact, when the net 2 is completely wound around the roller of the fixed box 3, at least one tape 5 (and possibly the link track 10) is fixed to the fixed box 3 and almost completely inserted in the duct 6b.

With the transition from the first configuration to the second configuration, the movable box 4 performs a translational motion which is kept on course by the guiding seat provided in the tape 5, which simultaneously and progressively exits from the duct 6b, being accommodated in the bezel 7 together with the extracted portion, which coincides with the first portion 5b (just as the link track 10 can in turn be partially accommodated in the duct 6b and partially lodged in a second bezel 7, opposite to the other one).

The movable box 4 can thus be brought to the second configuration, in which it completely screens the opening, thus impeding the passage of insects and the like. It should be noted moreover that the possibility exists of providing the mosquito screen 1 with devices that are capable of keeping the net 2 completely unwound (in the second configuration, therefore). For example, the movable box 4 can be associated with a rib 14 which is made of a material that can be magnetically fixed to a fixed band 15, which is stably anchored to the margin of the opening (and possibly of the fixed frame of the window or of the door) which is opposite to the margin with which the fixed box 3 is associated.

Thus at every moment, the movable box 4 is guided in translational motion by the tape 5 (and by the bezel 7), and at the same time the choice to use a tape 5 and a link track 10 (which slide side by side and in the opposite direction in the duct 6b of the profile 6) increases the guarantee of a correct guiding of the net 2 and especially of the first end flap 2a, which thus cannot be bent and inclined.

Such result therefore can be obtained by using a tape 5, without the need to use link tracks 10 (or by using only one of them, where the specific requirements advise it, in such a way as to complement the tape 5). This determines a reduction in costs and in encumbrances, in light of the utterly slender thickness of the tape 5 itself.

Moreover, as described in the foregoing paragraphs, the tape 5 can be kept constantly hidden from view (thanks to the bezel 7 that accommodates the first portion 5b and thanks to the profile 6 of the movable box 4 which accommodates the second portion 5c) and this ensures that a pleasing and attractive design is obtained.

In practice it has been found that the movable mosquito screen according to the invention fully achieves the set aim, in that the use of a frame of the mosquito screen, provided with a flexible tape, which is fixed with a first end thereof to the fixed box from which the net is unwound, and has a transverse cross-section that is at least partially U-shaped, in order to form a guiding seat for at least one corresponding end portion of the movable box which is fixed to the net on the side opposite to the fixed box, and for the net 2, makes it possible to provide a movable mosquito screen that is aesthetically pleasing and is provided with means for guiding the net that is deployed to screen the window, door, or the like, on which it is installed.

The invention, thus conceived, is susceptible of numerous modifications and variations, all of which are within the scope of the appended claims. Moreover, all the details may be substituted by other, technically equivalent elements.

In the embodiments illustrated, individual characteristics shown in relation to specific examples may in reality be interchanged with other, different characteristics, existing in other embodiments.

In practice, the materials employed, as well as the dimensions, may be any according to requirements and to the state of the art.

The disclosures in Italian Patent Application No. BO2011A000614 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-9. (canceled)

10. A movable mosquito screen, particularly for windows, doors and the like, comprising a fine mesh net which is provided with a substantially perimetric frame that can be installed at an opening in an element of the type of a wall and the like, said frame comprising a fixed box, which is coupled to an edge of said net and is associated stably with a corresponding margin of the opening, and a movable box, which is fixed on the side opposite to said net and can perform a translational motion on command, along a direction that is substantially perpendicular to said fixed box, for transition from a first configuration, in which said net is substantially gathered around said fixed box, to a second configuration, in which said net is extended so as to block said opening, and vice versa, wherein said substantially perimetric frame comprises at least one flexible tape, which is fixed with a first end thereof to said fixed box and has a transverse cross-section that is at least partially U-shaped, so as to form a guiding seat for at least one corresponding end portion of said movable box and for said net.

11. The movable mosquito screen according to claim 10, wherein said movable box comprises a profile, which forms on the inside a channel which is designed to receive a first end flap of said net and is opposite to said fixed box, in said first configuration said tape being contained substantially in an internal duct of said profile, during the transition from said first configuration to said second configuration said tape exiting progressively from said duct with a first portion, a second portion of said tape, which is complementary to said first portion, remaining inserted in said duct of said profile.

12. The movable mosquito screen according to claim 11, wherein said first portion, provided with said first end which is fixed to said fixed box, is extended transversely to said fixed box and to said movable box and is accommodated in a curved bezel.

13. The movable mosquito screen according to claim 11, wherein said net has a substantially rectangular shape, said fixed box and said movable box being arranged at the vertical sides of said net, when said frame is installed in the opening, said first portion of said tape substantially facing either the upper horizontal side or the lower horizontal side of said net.

14. The movable mosquito screen according to claim 11, further comprising a terminal, which is fixed to a second end of said tape, which is opposite to said first end, for reference by an apparatus for tensioning said tape, said terminal comprising a plate, which can be fixed to said second end of said tape and is arranged substantially on the plane of said second portion.

15. The movable mosquito screen according to claim 14, wherein said terminal has two flat wings, which are anchored at right angles to the sides of said plate, the center distance of said wings being substantially equal to the width of said duct, for their sliding along its internal surface and the consequent guiding of the movement of said second portion inside said duct of said profile.

16. The movable mosquito screen according to claim 11, wherein said frame comprises said tape and a link track, which are fixed to opposite ends of said fixed box and both face said net, said link track being constituted by a plurality of segments which are articulated in pairs and forming, with respective contoured walls of each one of said segments, a guiding groove for the respective end portion of said movable box, and for said net, said contoured walls of said segments having a center distance that is substantially equal to the width of said duct.

17. The movable mosquito screen according to claim 10, wherein said fixed box comprises a roller that can rotate about its own substantially vertical axis, in said first configuration said net being wound around said roller, during the transition from said first configuration to said second configuration said net unwinding from said roller and moving progressively so as to close said opening.

18. The movable mosquito screen according to claim 11, further comprising a stiffening stem, which is inserted in an inner sheath of said first end flap of said net and can be accommodated with said first end flap inside said profile.
